(19) United States
(12) Patent Application Publication
(10) Pub. No.: US 2020/0314414 A1
(43) Pub. Date: Oct. 1, 2020

(54) DISPLAY DEVICE AND DISPLAY CONTROL METHOD FOR DISPLAY DEVICE

(71) Applicant: Mitsubishi Electric Corporation, Tokyo (JP)

(72) Inventor: Shohei YASUDA, Tokyo (JP)

(73) Assignee: Mitsubishi Electric Corporation, Tokyo (JP)

(21) Appl. No.: 16/825,675

(22) Filed: Mar. 20, 2020

(30) Foreign Application Priority Data
Mar. 25, 2019 (JP) 2019-056334

(51) Int. Cl. H04N 13/315; H04N 13/312

(52) U.S. Cl. CPC H04N 13/315; H04N 13/312

(57) ABSTRACT

A display device includes a controller configured to perform control of bringing a predetermined number of adjacent openings into a first state being one state of a light transmitting state and a light shielding state to form a plurality of first state parts. The controller changes a potential of all of a plurality of electrodes to any of a first potential, a predetermined potential between the first potential and a second potential, and the second potential. After the change, the controller moves the first state parts.

### BACKGROUND OF THE INVENTION

### Field of the Invention

The present invention relates to a display device capable of stereoscopic display, and a display control method for the display device.

### Description of the Background Art

In recent years, display devices that allow the observer to visually recognize a stereoscopic image have been becoming widespread. To realize visual recognition of a stereoscopic image, a method combining a display panel that displays right-eye images and left-eye images partially different from each other, and a barrier structure that enables the right eye and the left eye to respectively visually recognize the right-eye images and the left-eye images has been proposed.

As the barrier structure, a parallax barrier method using a parallax barrier panel in which vertical slit-like light transmitting parts and vertical slit-like shutter parts (light shielding parts) provided in front of or behind the display panel are alternately arrayed in the horizontal direction has been known. According to the parallax barrier method, the observer can visually recognize a stereoscopic image without the use of special glasses.

Note that, in the parallax barrier method, an area of the viewpoint that allows an image to be visually recognized as a normal stereoscopic object is limited. If the viewpoint of the observer is outside of the area, 3D crosstalk occurs, in which both the right-eye image and the left-eye image exist, and thus it is difficult for the observer to visually recognize a stereoscopic image. In view of this, to substantially extend the viewpoint area, a system of detecting information of the current viewpoint position of the observer and changing the position of the light transmitting part and the shutter part of the barrier according to the viewpoint position has been proposed (for example, Japanese Patent Application Laid-Open No. 8-322068 (1996)).

As the parallax barrier panel allowing free position movement of the light transmitting part and the shutter part, for example, a liquid crystal panel is used. In the liquid crystal panel, light transmission and non-transmission states can be controlled by changing voltages to be applied to liquid crystals and thereby changing orientation of liquid crystal molecules, as well as changing a polarizing state.

In the configuration of controlling liquid crystals by using voltages, a plurality of slit electrodes (barrier electrodes), each linearly extending on a substrate of the parallax barrier panel, are disposed for each pixel of the display panel at a pitch narrower than the pixel size of the display panel. On the entire surface of the counter substrate facing a substrate on which the slit electrodes are disposed, a common electrode to which a common potential is applied is provided, and liquid crystals are filled between these substrates. In a liquid crystal panel of a normally white type, a shutter part that blocks light is used when a potential difference between the slit electrode and the common electrode is large, and a light transmitting part that allows light transmission is used when the potential difference is small.

In the parallax barrier panel having a configuration as described above, a potential for entering one of the light transmitting state and the light shielding state is applied to each slit electrode, so that the light transmitting part and the shutter part move according to a detected position of viewpoint. In this manner, the right-eye image and the left-eye image are separately visually recognized by the right eye and the left eye, respectively, even when the observer moves.

In liquid crystals at a boundary portion between the electrode to be the shutter part and the electrode to be the light transmitting part, a leakage electric field from the electrode to be the shutter part is generated. Owing to the leakage electric field, reverse tilt, which is a state in which the alignment state of the liquid crystals has orientation substantially opposite to the normal alignment state, occurs at some position in the boundary portion.

If the light transmitting part and the shutter part do not move, the reverse tilt is fixed to the position, and if the light transmitting part and the shutter part move, the leakage electric field no longer affects the position and the reverse tilt is resolved over time. However, immediately after the light transmitting part and the shutter part move and before the reverse tilt is resolved, disclination, which is caused by unstable liquid crystal orientation and which may be a factor of light leakage, occurs near the reverse tilt. Further, there has been a problem that, if the resolution of the disclination takes time, the disclination is visually recognized by the observer as unevenness, and the display quality is reduced.

### SUMMARY

The present disclosure is made in view of the problem as described above, and has one object to provide a technology capable of addressing reduction in display quality of a display device.

In the present disclosure, a display device includes a display panel, a parallax barrier panel, and a controller. In the parallax barrier panel, a plurality of openings capable of being switched into a light transmitting state and a light shielding state with respect to light of the display panel are arrayed. The controller is configured to perform control of bringing a predetermined number of adjacent openings out of the plurality of openings into a first state being one state of the light transmitting state and the light shielding state to form a plurality of first state parts, and bringing remaining openings out of the plurality of openings into a second state being another state of the light transmitting state and the light shielding state, and is configured to control the plurality of first state parts to be movable. The parallax barrier panel includes a plurality of electrodes corresponding to the plurality of openings. When a potential of one of the plurality of electrodes is a first potential, one of the plurality of openings corresponding to the one of the plurality of electrodes of the first potential enters the first state. When a potential of one of the plurality of electrodes is a second potential, one of the plurality of openings corresponding to the one of the plurality of electrodes of the second potential enters the second state. The controller changes a potential of all of the plurality of electrodes to any of the first potential, a predetermined potential between the first potential and the second potential, and the second potential, and then moves the plurality of first state parts.

Reduction in display quality of a display device can be addressed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view schematically illustrating a configuration of a related display device.

FIG. 2 is a plan view illustrating a parallax barrier panel of the related display device.

FIG. 3 is a cross-sectional view schematically illustrating a configuration of the parallax barrier panel of the related display device.

FIG. 4 is a cross-sectional view schematically illustrating a configuration of the related display device.

FIG. 5 is a cross-sectional view schematically illustrating a configuration of the parallax barrier panel of the related display device.

FIG. 6 is a cross-sectional view schematically illustrating a configuration of the parallax barrier panel of the related display device.

FIG. 7 is a cross-sectional view schematically illustrating a configuration of the parallax barrier panel of the related display device.

FIG. 8 is a cross-sectional view schematically illustrating a configuration of the parallax barrier panel of the related display device.

FIG. 9 is a plan view illustrating the parallax barrier panel of the related display device.

FIG. 10 is a plan view illustrating the parallax barrier panel of the related display device.

FIG. 11 is a plan view illustrating the parallax barrier panel of the related display device.

FIG. 12 is a plan view illustrating the parallax barrier panel of the related display device.

FIG. 13 is a plan view illustrating the parallax barrier panel of the related display device.

FIG. 14 is a plan view illustrating the parallax barrier panel of the related display device.

FIG. 15 is a plan view illustrating states of a parallax barrier panel according to a first embodiment, as shown in the order of changes.

FIG. 16 is a cross-sectional view schematically illustrating a configuration of the parallax barrier panel according to the first embodiment.

FIG. 17 is a plan view illustrating states of a parallax barrier panel according to a second embodiment, as shown in the order of changes.

FIG. 18 is a plan view illustrating states of a parallax barrier panel according to a third embodiment, as shown in the order of changes.

FIG. 19 is a cross-sectional view schematically illustrating a configuration of the parallax barrier panel according to the third embodiment.

FIG. 20 is a cross-sectional view schematically illustrating a configuration of the parallax barrier panel according to the third embodiment.

FIG. 21 is a plan view illustrating states of a parallax barrier panel according to a modification, as shown in the order of changes.

### DESCRIPTION OF THE PREFERRED EMBODIMENTS

<Related Display Device>

First, before giving description of a stereoscopic display device being a display device according to embodiments of the present invention, a stereoscopic display device related thereto (hereinafter referred to as a “related display device”) will be described.

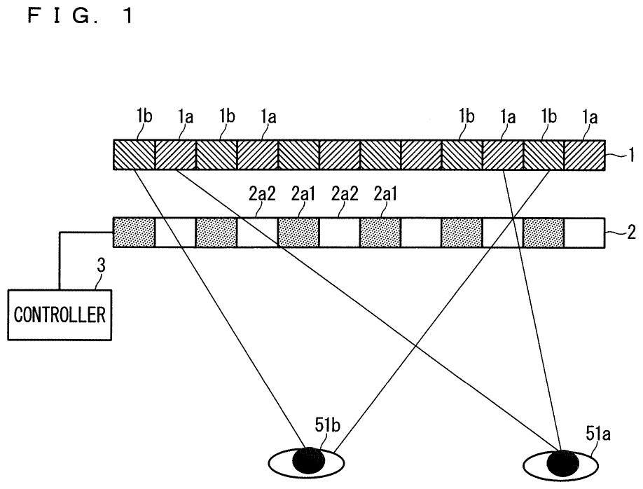

FIG. 1 is a cross-sectional view schematically illustrating a configuration of the related display device. The related display device includes a display panel 1, a parallax barrier panel 2, and a controller 3.

As the display panel 1, for example, a liquid crystal panel or the like is used. In the display panel 1, right-eye image parts 1a each being a part of a right-eye image to be visually recognized by a right eye 51a of the observer and left-eye image parts 1b each being a part of a left-eye image to be visually recognized by a left eye 51b of the observer are alternately arrayed in a planar shape. Note that the right-eye images and the left-eye images are partially different from each other in a degree of causing parallax.

As the parallax barrier panel 2, for example, a Twisted Nematic (TN) liquid crystal panel not including a color filter and a black matrix is used.

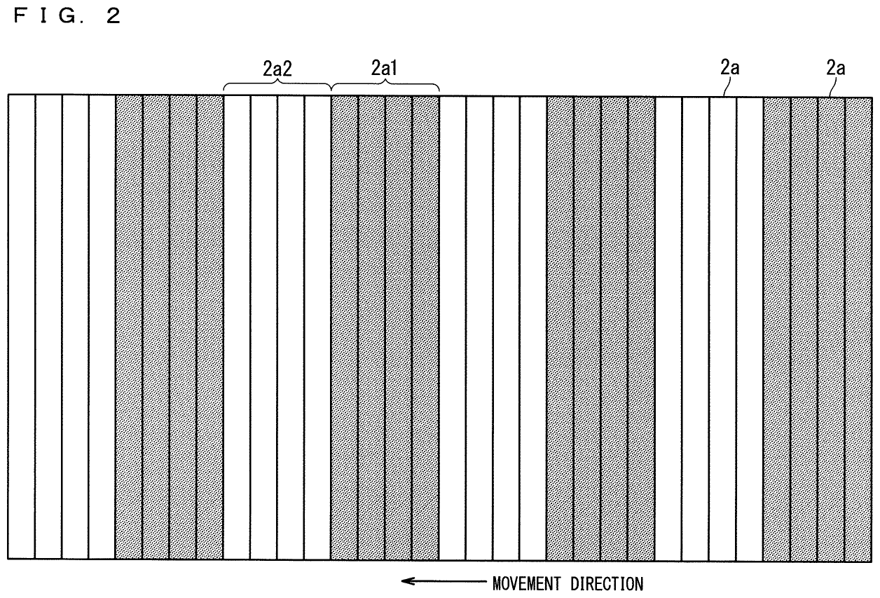

FIG. 2 is a plan view illustrating the parallax barrier panel 2. In the parallax barrier panel 2, a plurality of vertical slit-like openings 2a are arrayed in the same direction (horizontal direction) as the array direction of the right-eye image parts 1a and the left-eye image parts 1b. Further, in the plurality of openings 2a, a light transmitting state and a light shielding state can be switched with respect to light of the display panel 1. Note that, in the parallax barrier panel 2 of FIG. 1, FIG. 2, and the subsequent figures, the openings 2a in the light shielding state are hatched with dots, whereas the openings 2a in the light transmitting state are not hatched with dots.

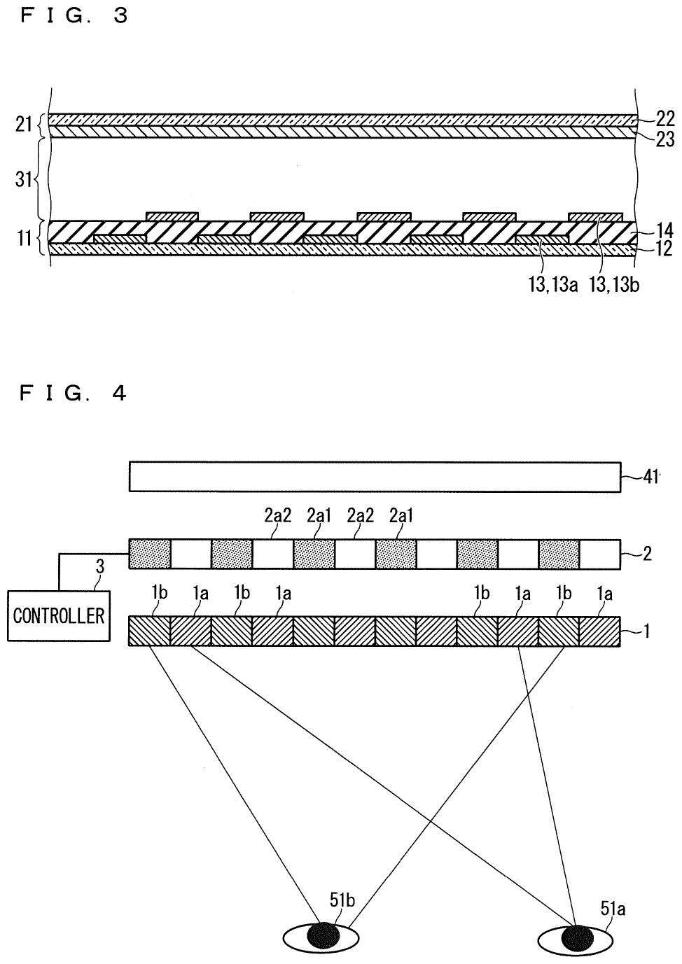

FIG. 3 is a cross-sectional view illustrating a configuration of the parallax barrier panel 2. The parallax barrier panel 2 of FIG. 3 includes an electrode-side substrate 11, a counter substrate 21, and a liquid crystal layer 31. Note that, although not illustrated in FIG. 3 etc., the parallax barrier panel 2 also includes a switching element, an alignment film, and a polarizing film, for example, similarly to a general liquid crystal panel.

The electrode-side substrate 11 includes a transparent substrate 12, a plurality of barrier electrodes 13, and an insulation film 14. The plurality of barrier electrodes 13 are each a transparent electrode made of indium tin oxide (ITO) or the like, for example, and include lower electrodes 13a provided on the transparent substrate 12 and upper electrodes 13b provided on the insulation film 14.

The plurality of barrier electrodes 13 correspond to the plurality of openings 2a of FIG. 2, and the area of each barrier electrode 13 is the same, or substantially the same, as the area of each opening 2a in plan view. To reduce liquid crystal screen burn due to a DC voltage, an AC voltage is appropriately applied to the plurality of barrier electrodes 13. The pitch of the plurality of barrier electrodes 13 corresponds to the pitch of a plurality of pixels of the display panel 1, and a part of the light of the pixels is blocked or allowed to transmit according to the potential of each barrier electrode 13. As in FIG. 3, owing to the configuration of alternately providing the plurality of barrier electrodes 13 in the upper layer and the lower layer, narrow-pitch openings 2a can be realized.

The counter substrate 21 and the electrode-side substrate 11 interpose the liquid crystal layer 31. The counter substrate 21 includes a transparent substrate 22, and a common electrode 23 provided on the transparent substrate 22. A steady potential is applied to the common electrode 23.

On the surface of the transparent substrate 12 and the transparent substrate 22 opposite to the liquid crystal layer 31, a polarizing plate for blocking or allowing transmission of light from the display panel 1 according to an alignment state (tilting state) of liquid crystal molecules of the liquid crystal layer 31 is provided. Further, on the surface of the transparent substrate 12 and the transparent substrate 22 on the liquid crystal layer 31 side, an alignment film for substantially defining the alignment state of the liquid crystal molecules of the liquid crystal layer 31 is provided. The alignment film forms a pretilt angle of the liquid crystal molecules when being rubbed.

Here, if the potential of the barrier electrode 13 is a high potential (first potential), the opening 2a corresponding to the barrier electrode 13 enters a first state being one state of the light transmitting state and the light shielding state. In contrast, if the potential of the barrier electrode 13 is a low potential (second potential) being lower than the high potential, the opening 2a corresponding to the barrier electrode 13 enters a second state being the other state of the light transmitting state and the light shielding state. A plurality of first state parts are formed by a predetermined number of adjacent openings 2a in the first state, and a second state part is formed by the remaining apertures 2a in the second state.

The following description will be given on the assumption that the parallax barrier panel 2 is a liquid crystal panel of a normally white type. In this case, the first state is the light shielding state, the first state part is a shutter part 2a1 as in FIG. 2, the second state is the light transmitting state, and the second state part is a light transmitting part 2a2 (opening part) as in FIG. 2.

However, the parallax barrier panel 2 is not limited to this, and may be, for example, a liquid crystal panel of a normally black type. In this case, the first state is the light transmitting state, the first state part is the light transmitting part, the second state is the light shielding state, and the second state part is the shutter part. Note that “potential” herein has substantially the same meaning as “voltage”.

Further, in the following description, the pitch between the shutter part 2a1 and the light transmitting part 2a2 is the same as the pixel pitch of the display panel 1. Note that the number of openings 2a forming the shutter part or the light transmitting part may be appropriately changed, on the condition that a plurality of openings 2a are provided.

According to the configuration as described above, as illustrated in FIG. 1, the left-eye image part 1b does not enter the right eye 51a owing to the shutter part 2a1, whereas the right-eye image part 1a enters the right eye 51a through the light transmitting part 2a2. In contrast, the right-eye image part 1a does not enter the left eye 51b owing to the shutter part 2a1, whereas the left-eye image part 1b enters the left eye 51b through the light transmitting part 2a2. As a result, the observer can visually recognize stereoscopic display of the stereoscopic display device.

Note that, in the example of FIG. 1, the parallax barrier panel 2 is disposed closer to the observer than the display panel 1, but this configuration is not restrictive. For example, in the configuration of using light of a backlight 41 as illustrated in FIG. 4, the display panel 1 may be disposed closer to the observer than the parallax barrier panel 2. Also with such a configuration of FIG. 4, the observer can visually recognize stereoscopic display of the stereoscopic display device similarly to FIG. 1.

The controller 3 illustrated in FIG. 1 etc. includes a central processing unit (CPU), for example, and controls the light transmitting state and the light shielding state of the plurality of openings 2a of the parallax barrier panel 2. According to the control, the shutter part 2a1 and the light transmitting part 2a2 of FIG. 2 described above are formed.

Further, an observer position detector including a camera or the like (not illustrated) provided outside or inside the related display device detects position information of the observer. The controller 3 controls the light transmitting state and the light shielding state, based on the position information detected by the observer position detector. The controller 3 controls the light transmitting state and the light shielding state according to the movement of the observer, and thereby controls the shutter part 2a1 and the light transmitting part 2a2 to be movable along the array direction (horizontal direction) of the plurality of openings 2a.

In this manner, the shutter part 2a1 and the light transmitting part 2a2 are moved to follow the movement of the position of the viewpoint, so that the viewpoint of the observer is located in the area allowing visual recognition of a stereoscopic image. Therefore, the right-eye image part 1a and the left-eye image part 1b can respectively enter the right eye 51a and the left eye 51b even when the observer moves, and thus the observer can visually recognize stereoscopic display of the stereoscopic display device.

Next, problems of the related display device will be described. FIG. 5 is a cross-sectional view illustrating an example of an alignment state of liquid crystal molecules 32 of the liquid crystal layer 31 of the parallax barrier panel 2 of the related display device. Note that, for the sake of simplifying the drawings, some of the reference signs of FIG. 3 are omitted from the cross-sectional views of FIG. 5 and the subsequent figures.

In the normally white type, if the potential of the barrier electrode 13 is a low potential (for example, a common potential), the liquid crystal molecules 32 around the barrier electrode 13 enter an alignment state substantially defined by the alignment film (for example, an alignment state parallel with the substrate), and the opening corresponding to the barrier electrode 13 enters the light transmitting state. In contrast, if the potential of the barrier electrode 13 is a high potential, the liquid crystal molecules 32 around the barrier electrode 13 enter an alignment state substantially defined by a vertical electric field between the barrier electrode 13 and the common electrode 23 (for example, an alignment state vertical to the substrate), and the opening corresponding to the barrier electrode 13 enters the light shielding state.

Here, at a boundary portion between the shutter part 2a1 and the light transmitting part 2a2, a leakage electric field being an electric field leaking from the barrier electrode 13 corresponding to the shutter part 2a1 to the light transmitting part 2a2 is generated. The leakage electric field is generated at each of the left end and the right end of the shutter part 2a1 of FIG. 5. At one of these ends (left end of FIG. 5), reverse tilt 33 occurs, which is a state in which the alignment state of the liquid crystal molecules 32 has orientation substantially opposite to the normal alignment state according to rubbing. Further, immediately after the shutter part 2a1 is moved, disclination, which is caused by unstable liquid crystal orientation and which may be a factor of light leakage, occurs near the reverse tilt 33.

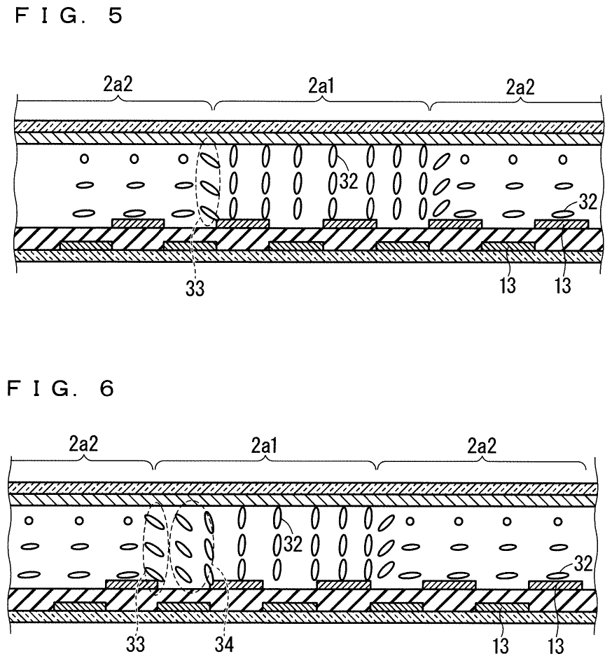

FIG. 6 is a cross-sectional view illustrating an alignment state of the liquid crystal molecules 32 immediately after the shutter part 2a1 is moved toward the reverse tilt 33 side (leftward) by one barrier electrode 13 from the liquid crystal alignment state of FIG. 5. In FIG. 6, the high potential is applied to the barrier electrode 13 near the reverse tilt 33 of FIG. 5, and thus the opening of the barrier electrode 13 is supposed to transition from the light transmitting state to the light shielding state. However, in this case, in a region between the boundary portion where the reverse tilt 33 occurs in the state of FIG. 5 and the boundary portion where new reverse tilt 33 occurs in the state of FIG. 6, disclination 34 occurs, bringing the alignment state to a state similar to the reverse tilt 33. The region where the disclination 34 occurs does not fully enter the light shielding state, but enters a light leakage state allowing slight light transmission.

Note that, at the other end (right end of FIG. 5) opposite to the one end where the reverse tilt 33 occurs out of the left end and the right end of the shutter part 2a1 of FIG. 5, the alignment state of the liquid crystal molecules 32 affected by the leakage electric field has substantially the same orientation as the normal alignment state (normal direction) according to rubbing. Further, the movement of the shutter part 2a1 and the light transmitting part 2a2 leads to the normal light transmitting state in which the leakage electric field is resolved as in FIG. 6. Therefore, disclination does not occur at the other end (right end of FIG. 6) opposite to the one end where the reverse tilt 33 occurs.

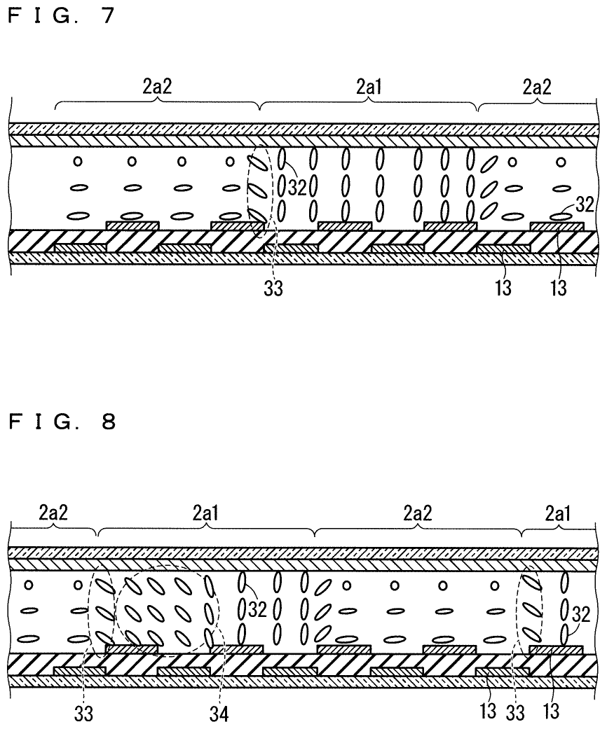

FIG. 7 is a cross-sectional view illustrating an alignment state of the liquid crystal molecules 32 immediately after the shutter part 2a1 moves toward the opposite side of the movement direction of FIG. 6 (rightward) by one barrier electrode 13 from the liquid crystal alignment state of FIG. 5. At the left end where the reverse tilt occurs due to the leakage electric field in FIG. 5, the leakage electric field is resolved and the state returns to the normal alignment state, and therefore disclination does not occur. Further, at the right end having a tilt in the normal direction due to the leakage electric field in FIG. 5, the liquid crystal molecules 32 directly tilt in the normal direction, and therefore disclination does not occur. As can be seen from the comparison between FIG. 6 and FIG. 7, occurrence of the disclination 34 depends on the movement direction of the shutter part 2a1 and the light transmitting part 2a2.

Incidentally, the disclination 34 as in FIG. 6 occurring from the reverse tilt 33 is restored to the normal liquid crystal alignment state over time, and eventually reaches a state in which only the reverse tilt 33 remains. However, if the shutter part 2a1 further moves toward the reverse tilt 33 side before the disclination 34 is resolved, the area of the disclination spreads.

FIG. 8 is a cross-sectional view illustrating an alignment state of the liquid crystal molecules 32 immediately after the shutter part 2a1 moves toward the reverse tilt 33 side (leftward) by one barrier electrode 13 from the liquid crystal alignment state of FIG. 6. In this case, disclination 34 occurs in a region between the boundary portion where the reverse tilt 33 occurs in the state of FIG. 5 and the boundary portion where new reverse tilt 33 occurs in the state of FIG. 8. If the disclinations 34 occur one after another as described above, it takes more time to resolve the disclinations 34, and the disclinations 34 remain for a long period of time.

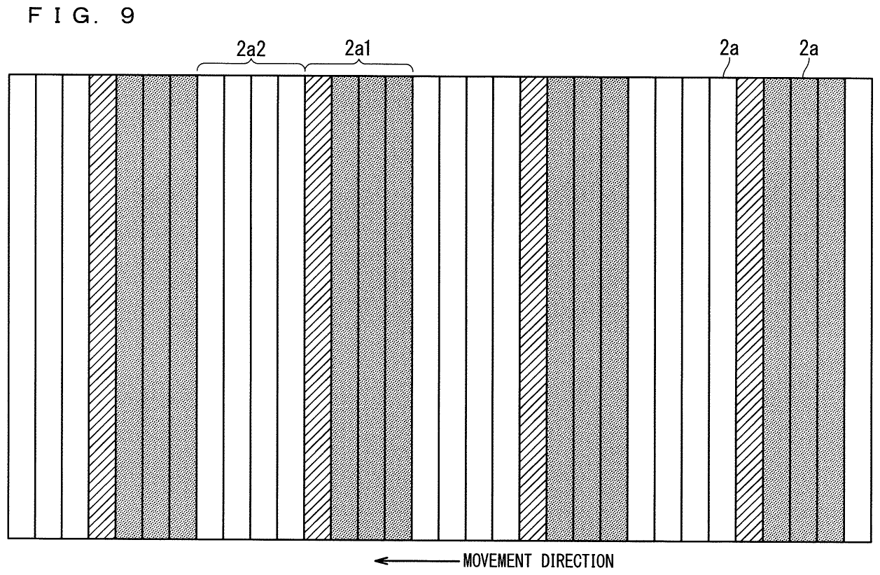

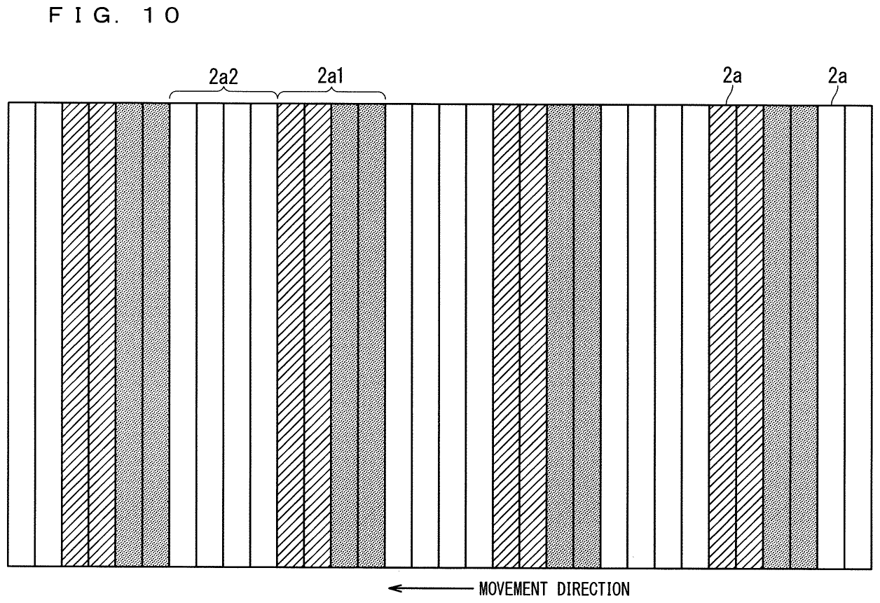

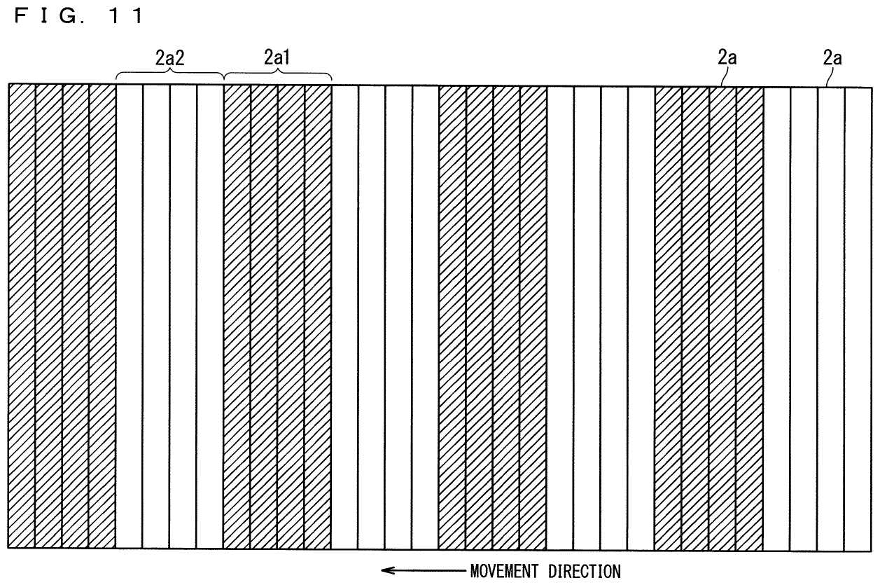

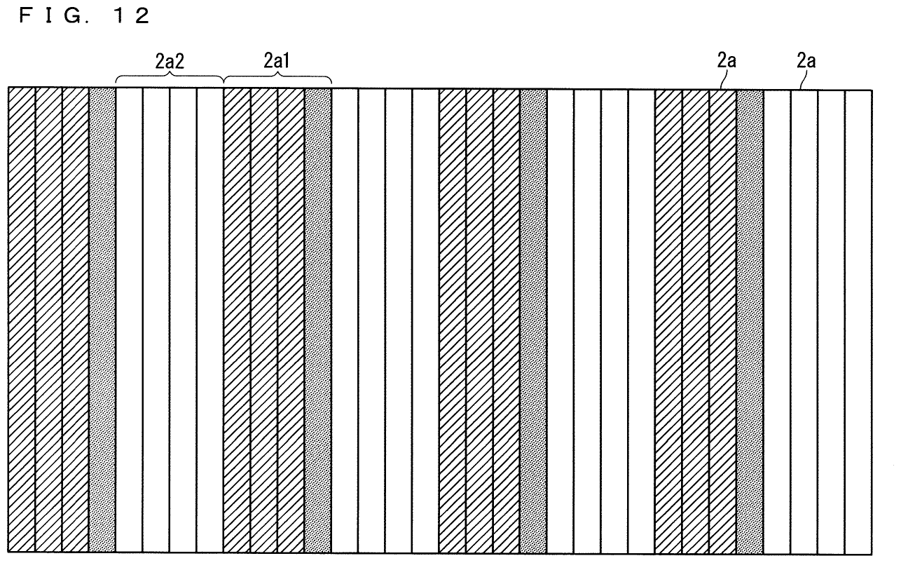

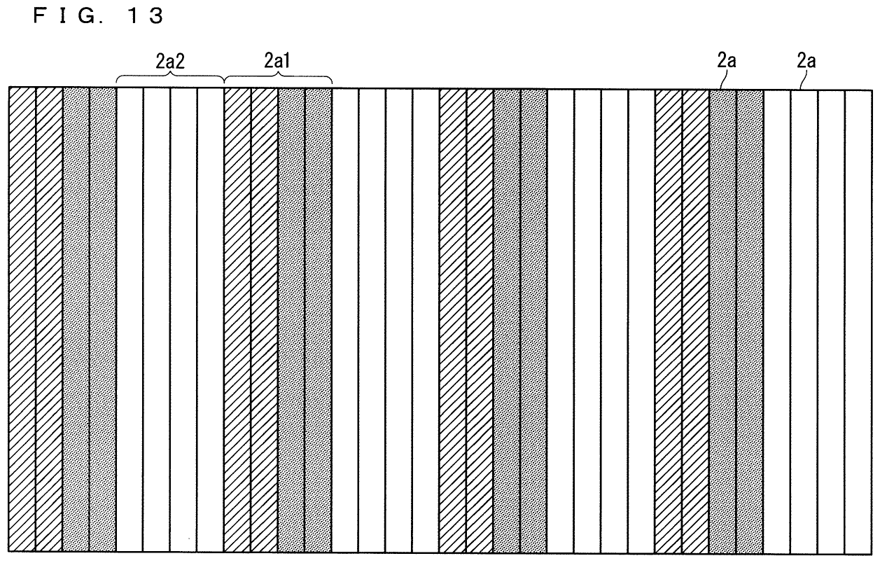

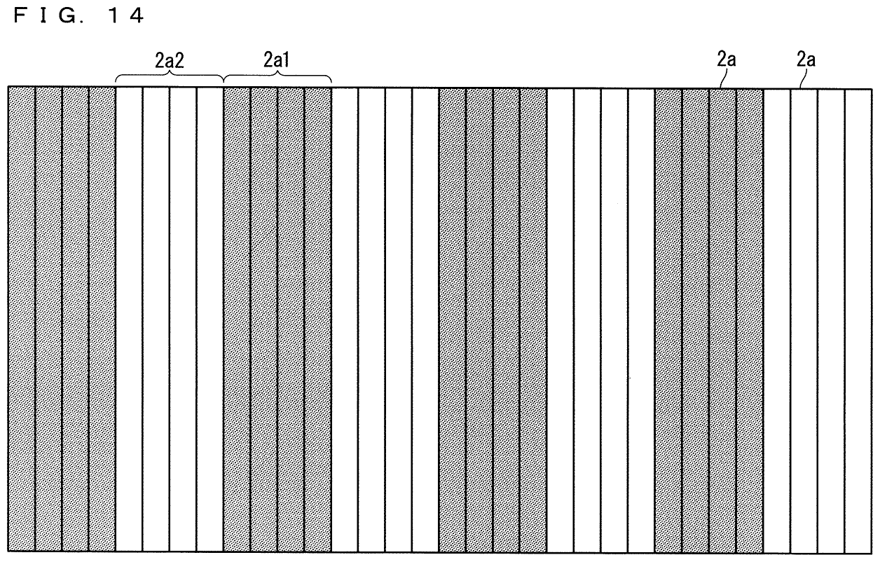

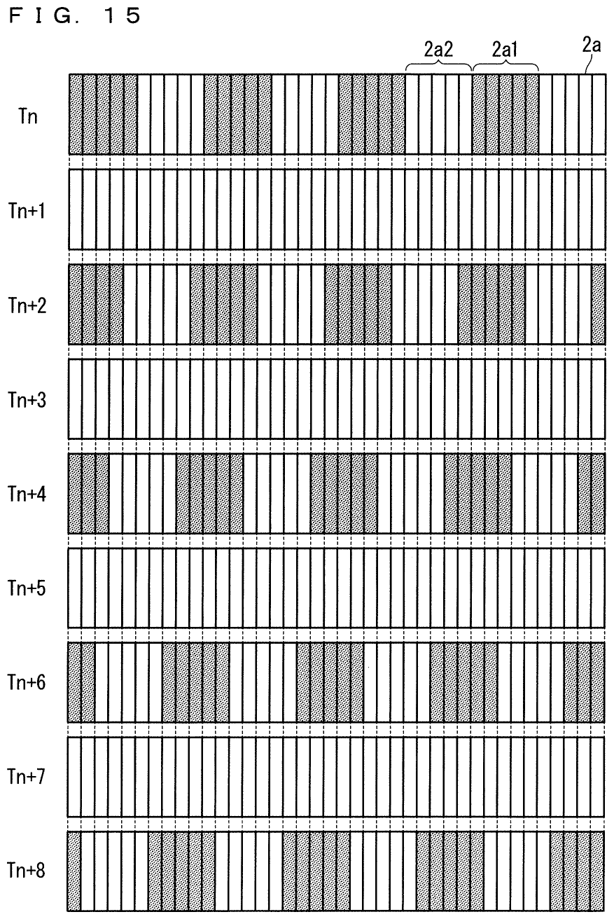

FIG. 9 to FIG. 11 are each a diagram illustrating a state transition when the shutter part 2a1 and the light transmitting part 2a2 move toward the reverse tilt side from the state of FIG. 2. FIG. 12 to FIG. 14 are each a diagram illustrating a state transition when the shutter part 2a1 and the light transmitting part 2a2 do not move after the state of FIG. 11. Even when the disclinations 34 occur one after another due to the movement of the shutter part 2a1 and the light transmitting part 2a2 (FIG. 9 to FIG. 11), the disclinations 34 are eventually resolved over time (FIG. 12 to FIG. 14). However, in such a case, the disclinations 34 remains for a relatively long period of time.

As has been described above, the related display device is relatively more affected by light leakage due to the disclination 34. Therefore, the right-eye images and the left-eye images may be mixed, and unevenness due to non-uniformity of luminance of the shutter part 2a1 may be visually recognized. In addition, there has been a problem that such inconvenience becomes more notable as the shutter part 2a1 and the light transmitting part 2a2 further move due to viewpoint movement. In comparison to this, a stereoscopic display device according to the embodiments described below can solve the problem.

### First Embodiment

Components of a stereoscopic display device according to a first embodiment of the present invention are substantially the same as the components of the related display device. Thus, in the following description, among the components according to the first embodiment, components that are the same as or similar to the above-described components are denoted by the same or similar reference signs, and different components will be mainly described.

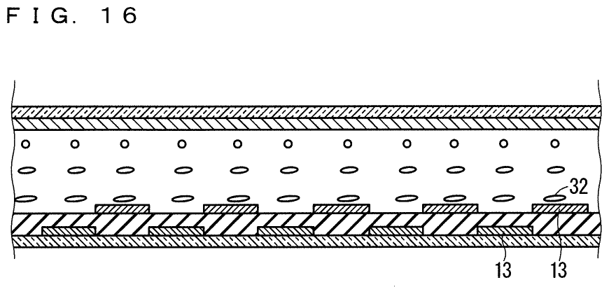

FIG. 15 is a plan view illustrating states of the openings 2a of the parallax barrier panel 2 under the control of the controller 3 according to the first embodiment, as shown in the order of changes. At timings Tn+1, Tn+3, Tn+5, and Tn+7 of FIG. 15, the potential of all of the plurality of barrier electrodes 13 is changed to a low potential for bringing the openings 2a to the light transmitting state. In this manner, the controller 3 changes the potential of all of the plurality of barrier electrodes 13 to the low potential for bringing the openings 2a to the light transmitting state, and then moves the shutter part 2a1 and the light transmitting part 2a2. Note that, in the movement of the shutter part 2a1 and the light transmitting part 2a2, for example, movement by one opening 2a, a change of the number of openings 2a constituting those, or the like is applied.

FIG. 16 is a cross-sectional view illustrating an alignment state of the liquid crystal molecules 32 when the potential of all of the plurality of barrier electrodes 13 is changed to the low potential. The liquid crystal molecules 32 at the reverse tilt 33 illustrated in FIG. 5 etc. enter a tilt state similar to the liquid crystal molecules 32 of the normal light transmitting part 2a2 as in FIG. 16, and the reverse tilt 33 is resolved. Therefore, the occurrence of the disclination 34 of FIG. 6 can be reduced even if the shutter part 2a1 and the light transmitting part 2a2 are moved afterwards.

### Overview of First Embodiment

The controller 3 of the stereoscopic display device according to the first embodiment as described above changes the potential of all of the plurality of barrier electrodes 13 to the low potential for bringing the openings 2a to the light transmitting state, and then moves the shutter part 2a1 and the light transmitting part 2a2. According to such a configuration, occurrence of disclination can be reduced. Consequently, reduction in display quality of the stereoscopic display device due to disclination can be addressed.

### Second Embodiment

Components of a stereoscopic display device according to a second embodiment of the present invention are substantially the same as the above-described components. Thus, in the following description, among the components according to the second embodiment, components that are the same as or similar to the above-described components are denoted by the same or similar reference signs, and different components will be mainly described.

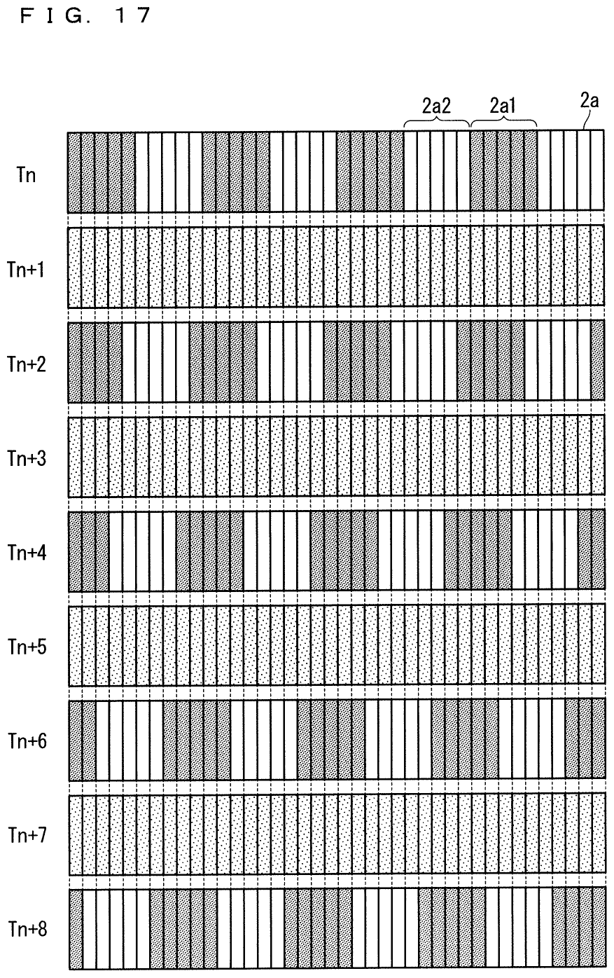

FIG. 17 is a plan view illustrating states of the openings 2a of the parallax barrier panel 2 under the control of the controller 3 according to the second embodiment, as shown in the order of changes. At timings Tn+1, Tn+3, Tn+5, and Tn+7 of FIG. 17, the potential of all of the plurality of barrier electrodes 13 is changed to an intermediate potential being any potential between the low potential for bringing the openings 2a to the light transmitting state and a high potential for bringing the openings 2a to the light shielding state. As described above, the controller 3 changes the potential of all of the plurality of barrier electrodes 13 to the intermediate potential, and then moves the shutter part 2a1 and the light transmitting part 2a2. Note that, in the movement of the shutter part 2a1 and the light transmitting part 2a2, for example, movement by one opening 2a, a change of the number of openings 2a constituting those, or the like is applied.

### Overview of Second Embodiment

The controller 3 of the stereoscopic display device according to the second embodiment as described above changes the potential of all of the plurality of barrier electrodes 13 to the intermediate potential, and then moves the shutter part 2a1 and the light transmitting part 2a2. According to such a configuration, occurrence of disclination can be reduced. Consequently, reduction in display quality of the stereoscopic display device due to disclination can be addressed. Further, the luminance of a pattern for reducing the occurrence of disclination according to the second embodiment (pattern of timings Tn+1, Tn+3, Tn+5, and Tn+7 of FIG. 17) is lower than the luminance according to the first embodiment. Therefore, unevenness due to a change of the luminance caused by the pattern can be reduced.

### Third Embodiment

Components of a stereoscopic display device according to a third embodiment of the present invention are substantially the same as the above-described components. Thus, in the following description, among the components according to the third embodiment, components that are the same as or similar to the above-described components are denoted by the same or similar reference signs, and different components will be mainly described.

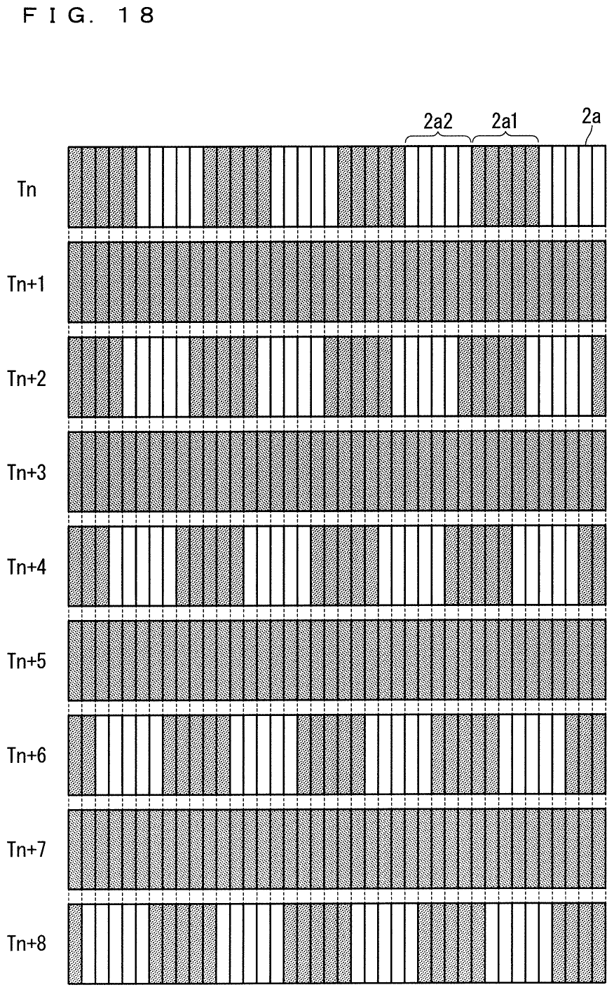

FIG. 18 is a plan view illustrating states of the openings 2a of the parallax barrier panel 2 under the control of the controller 3 according to the third embodiment, as shown in the order of changes. At timings Tn+1, Tn+3, Tn+5, and Tn+7 of FIG. 18, the potential of all of the plurality of barrier electrodes 13 is changed to a high potential for bringing the openings 2a to the light shielding state. As described above, the controller 3 changes the potential of all of the plurality of barrier electrodes 13 to the high potential for bringing the openings 2a to the light shielding state, and then moves the shutter part 2a1 and the light transmitting part 2a2. Note that, in the movement of the shutter part 2a1 and the light transmitting part 2a2, for example, movement by one opening 2a, a change of the number of openings 2a constituting those, or the like is applied.

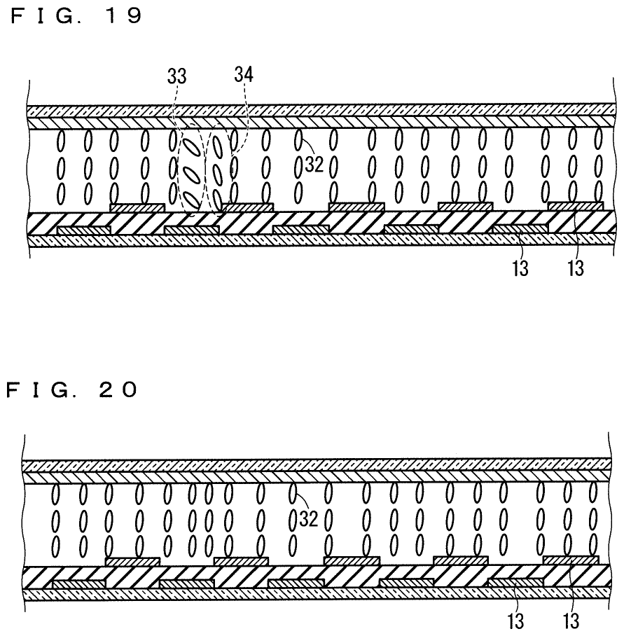

FIG. 19 is a cross-sectional view illustrating an alignment state of the liquid crystal molecules 32 immediately after the potential of all of the plurality of barrier electrodes 13 is changed to the high potential. The liquid crystal molecules 32 at the reverse tilt 33 and the disclination 34 illustrated in FIG. 6 etc. exist immediately after the potential change even in the third embodiment as in FIG. 19. However, the liquid crystal molecules 32 around these tilt in the normal tilt direction. Therefore, the liquid crystal molecules 32 at the reverse tilt 33 and the disclination 34 are prompted to tilt in the normal tilt direction. As a result, as illustrated in FIG. 20, a state in which the reverse tilt 33 and the disclination 34 are resolved can be achieved in a short period of time.

### Overview of Third Embodiment

The controller 3 of the stereoscopic display device according to the third embodiment as described above changes the potential of all of the plurality of barrier electrodes 13 to the high potential for bringing the openings 2a to the light shielding state, and then moves the shutter part 2a1 and the light transmitting part 2a2. According to such a configuration, the time period of occurrence of the disclination 34 can be reduced. Consequently, reduction in display quality of the stereoscopic display device due to disclination can be addressed.

<Modification>

In the above description, the controller 3 changes the potential of all of the plurality of barrier electrodes 13 to any of the low potential, the intermediate potential, and the high potential, and then moves the shutter part 2a1 and the light transmitting part 2a2. Further, after moving the shutter part 2a1 and the light transmitting part 2a2, the controller 3 may change the potential of all of the plurality of barrier electrodes 13 to any of the low potential, the intermediate potential, and the high potential, and may further move the shutter part 2a1 and the light transmitting part 2a2 after the change.

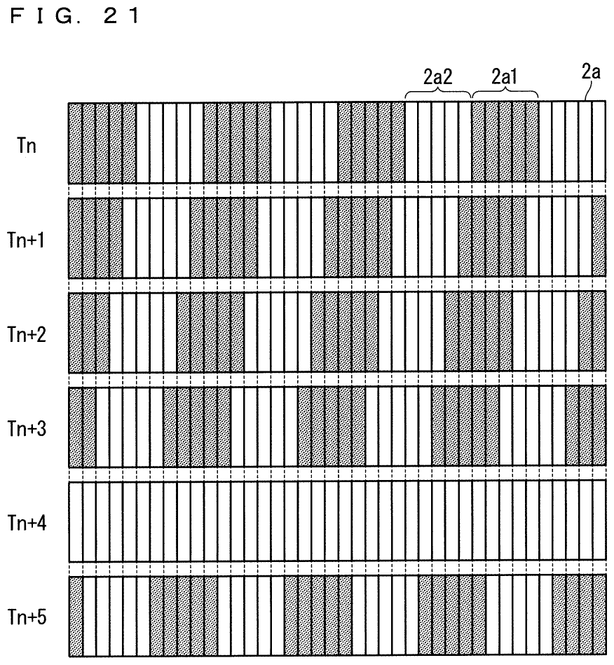

Further, even if the shutter part 2a1 and the light transmitting part 2a2 are moved a plurality of times, disclination may not be visually recognized. In that case, the controller 3 may be configured not to change the potential of all of the plurality of barrier electrodes 13 to any of the low potential, the intermediate potential, and the high potential, until the controller 3 moves the shutter part 2a1 and the light transmitting part 2a2 a plurality of times. FIG. 21 is a plan view illustrating states of the openings 2a of the parallax barrier panel 2 under the control of the controller 3 according to the modification, as shown in the order of changes. FIG. 21 illustrates an example in which the plurality of times is 3.

Note that the controller 3 may determine whether disclination is not visually recognized, when a series of movements of the shutter part 2a1 and the light transmitting part 2a2 corresponding to a series of movements of the observer is performed. Then, the controller 3 may be configured not to change the potential of all of the plurality of barrier electrodes 13 to any of the low potential, the intermediate potential, and the high potential until the series of movements ends, if the controller 3 determines that disclination is not visually recognized even after the series of movements of the shutter part 2a1 and the light transmitting part 2a2 is performed.

The modification as described above can make the pattern for reducing the occurrence of the disclination 34 less liable to affect display of the right-eye images and the left-eye images.

Note that, in the present invention, each of the embodiments and each of the modifications can be freely combined, and each of the embodiments and each of the modifications can be modified or omitted as appropriate, within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a display panel;
a parallax barrier panel in which a plurality of openings capable of being switched into a light transmitting state and a light shielding state with respect to light of the display panel are arrayed; and
a controller being configured to perform control of bringing a predetermined number of openings adjacent to each other out of the plurality of openings into a first state being one state of the light transmitting state and the light shielding state to form a plurality of first state parts, and bringing remaining openings out of the plurality of openings into a second state being another state of the light transmitting state and the light shielding state, and being configured to control the plurality of first state parts to be movable, wherein
the parallax barrier panel includes a plurality of electrodes corresponding to the plurality of openings,
when a potential of one of the plurality of electrodes is a first potential, one of the plurality of openings corresponding to the one of the plurality of electrodes of the first potential enters the first state,
when a potential of one of the plurality of electrodes is a second potential, one of the plurality of openings corresponding to the one of the plurality of electrodes of the second potential enters the second state, and
the controller changes a potential of all of the plurality of electrodes to any of the first potential, a predetermined potential between the first potential and the second potential, and the second potential, and then moves the plurality of first state parts.

2. The display device according to claim 1, wherein
after moving the plurality of first state parts, the controller changes the potential of all of the plurality of electrodes to any of the first potential, the predetermined potential, and the second potential, and further moves the plurality of first state parts after the change.

3. The display device according to claim 2, wherein
the controller does not change the potential of all of the plurality of electrodes to any of the first potential, the predetermined potential, and the second potential, until the controller moves the plurality of first state parts a plurality of times.

4. A display control method for a display device,
the display device including
a display panel, and
a parallax barrier panel in which a plurality of openings capable of being switched into a light transmitting state and a light shielding state with respect to light of the display panel are arrayed,
control of bringing a predetermined number of openings adjacent to each other out of the plurality of openings into a first state being one state of the light transmitting state and the light shielding state to form a plurality of first state parts, and bringing remaining openings out of the plurality of openings into a second state being another state of the light transmitting state and the light shielding state being performed, the plurality of first state parts being controlled to be movable,
the parallax barrier panel including a plurality of electrodes corresponding to the plurality of openings,
when a potential of one of the plurality of electrodes is a first potential, one of the plurality of openings corresponding to the one of the plurality of electrodes of the first potential entering the first state,
when a potential of one of the plurality of electrodes is a second potential, one of the plurality of openings corresponding to the one of the plurality of electrodes of the second potential entering the second state,
the display control method comprising
changing a potential of all of the plurality of electrodes to any of the first potential, a predetermined potential between the first potential and the second potential, and the second potential, and then moving the plurality of first state parts.

5. The display control method according to claim 4, further comprising
after moving the plurality of first state parts, changing the potential of all of the plurality of electrodes to any of the first potential, the predetermined potential, and the second potential, and further moving the plurality of first state parts after the change.

6. The display control method according to claim 5, further comprising
not changing the potential of all of the plurality of electrodes to any of the first potential, the predetermined potential, and the second potential, until the plurality of first state parts are moved a plurality of times.
